(19) United States
(12) Patent Application Publication
(10) Pub. No.: US 2013/0174492 A1
(43) Pub. Date: Jul. 11, 2013

(54) CO-EXTRUDED ROLL FORMED BRIGHT EXTRUSION WITH INTEGRAL END FORMS

(71) Applicants: Chris Laycoe, Northville, MI (US); Ron Hussey, Etocoke (CA); Clint Watts, Orangeville (CA); Bonnie-Lea Voros, Orangeville (CA)

(72) Inventors: Chris Laycoe, Northville, MI (US); John Voros, Georgetown (CA); Ron Hussey, Etocoke (CA); Clint Watts, Orangeville (CA)

(73) Assignee: Cooper-Standard Automotive, Inc., Novi, MI (US)

(21) Appl. No.: 13/582,249

(22) PCT Filed: Mar. 3, 2011
(86) PCT No.: PCT/US11/27062

§ 371 Date: Mar. 8, 2013

Related U.S. Application Data
(60) Provisional application No. 61/310,085, filed on Mar. 3, 2010.

(51) Int. Cl. B60J 10/04

(52) U.S. Cl. CPC B60J 10/04
USPC 49/475.1; 29/527.1

(57) ABSTRACT

A weatherstrip and associated method of forming the weatherstrip includes a body having a core formed of a first material and at least partially encapsulated in an extrusion material. A bright strip or metal show surface is integrated within the extrusion body to provide an aesthetically pleasing bright strip. The end of the bright strip is formed at an end of the weatherstrip to provide a one-piece structure.

This application claims priority from U.S. provisional patent application Ser. No. 61/310,085, filed Mar. 3, 2010.

### BACKGROUND OF THE DISCLOSURE

This application relates to a weatherstrip or weatherseal for an automotive vehicle and, more particularly, a weatherstrip that incorporates a bright strip or metal show surface and requires closed ends.

Oftentimes, weatherstrips are a multi-part assembly in which a rigid core is coextruded with an elastomer such as rubber, EPDM, or plastic. A separately formed bright strip is roll formed and mechanically assembled to the weatherstrip after the weatherstrip has been removed from the extrusion line. For example, the bright strip often has a generally C-shaped cross-section in which the bent or hooked longitudinal edges mechanically grip the previously cured weatherstrip. This bright strip is mechanically clinched to the weatherstrip so that two separate components (the weatherstrip and the bright strip) become a mechanically-joined assembly that includes the weatherstrip with the bright strip mechanically and subsequently joined to the weatherstrip.

The disclosure of commonly owned, co-pending U.S. application Ser. No. 12/600,424, filed Jun. 13, 2008 (published as WO 2008/157332) is directed to a weatherstrip used in an automotive vehicle that incorporates a bright strip or an integrated metal cosmetic strip. The bright strip is preferably a stainless steel or anodized metal (e.g., aluminum) that is integrally joined to an elastomer weatherstrip body. More particularly, the weatherstrip has a core that is received in the extrusion body and additionally a metal bright strip is integrated within the extrusion body, i.e., passes through the extrusion line, and the bright strip provides an aesthetically pleasing upper reveal or show surface. A removable cover layer may be extruded over the bright strip during the extrusion process in order to protect the outer show surface of the bright strip during the formation and handling process. Regions or areas of weakness are formed along an edge of the cover layer and provide for easy removal of the cover layer from the show surface of the bright strip, so that once the cover layer is removed, the weatherstrip has an exposed surface of a bright strip that is integrated into the weatherstrip with a reduced chance of potential damage to the exposed surface of the bright strip during the assembly process.

In both versions of the weatherstrip incorporating a bright strip as described above (i.e., one with an integrated, one-piece bright strip formed in situ in the extrusion process, or mechanically securing a separately formed bright strip to the extruded weatherstrip component), one or both ends of the weatherstrip are closed with an end cap. In the first arrangement where the bright strip is separately formed and subsequently mechanically engaged to the separate extrusion, the ends of the bright strip may be formed into an end, typically through a roll forming process. For example, multiple forming steps such as trimming and folding over are undertaken on the end of the bright strip to make the end form.

In the second arrangement, where the bright strip is integrally extruded with the remainder of the extruded weatherseal, separate end caps are typically formed and then subsequently attached to one or both ends of the weatherstrip.

Accordingly, a need exists for eliminating the necessity to use separate end caps, two-piece assemblies (using rolled or extruded metal), or molded ends in a weatherstrip with an integrated bright strip.

### SUMMARY OF THE DISCLOSURE

The weatherstrip includes a body having a core formed of a first material and at least partially encapsulated in an extrusion material. A bright strip or metal show surface is integrated or partially encapsulated with the extrusion body to provide an aesthetically pleasing bright strip. The end of the bright strip is formed at an end of the weatherstrip to provide a one-piece structure.

In selected end regions of the formed end, remaining portions of the weatherseal cross-section are removed.

In one embodiment, the bright strip is formed of a first metal, for example stainless steel.

In another embodiment, the core is made from a different, second metal such as aluminum.

In a preferred method of forming the weatherstrip having a bright strip show surface, a core is provided and a separate metal show surface is likewise provided. The core and bright strip are introduced into an extrusion die, and an elastomer body extruded over the core to secure the bright strip to the body. Portions of the extruded elastomer body are subsequently removed and at least one end of the metal show surface mechanically formed into a closed end.

The method includes removing extruded material from a rear surface of the bright strip to allow the metal bright strip to be formed into an end.

In one preferred arrangement, trimming and removing of the material from the extruded weatherstrip is accomplished with a water jet.

A primary benefit is the ability to replace a conventional two-piece design with a single piece extrusion with integrated, formed ends.

Yet other benefits include weight savings, fewer pieces, processing and cost savings associated with the vehicle.

Still another advantage resides in the elimination of at least one step in a conventional operation.

Still other features and benefits of the present disclosure will become apparent upon reading and understanding the following detailed description.

### BRIEF DESCRIPTION OF THE DRAWINGS

FIG. 1 is an elevational view of an automotive vehicle door illustrating various areas in which a weatherstrip with a bright strip may be used.

FIG. 2 is a cross-sectional view taken generally along the lines 2-2 of FIG. 1, for example forming an outer belt weatherstrip.

FIG. 3 is a prior art showing of the extrusion portion of the weatherstrip on the right-hand part of the Figure and the cap shown in the left part of the Figure.

FIG. 4 shows the completed two-part assembly of the extrusion and bright strip with cap from FIG. 3.

FIG. 5 is a view similar to FIG. 2 of an outer belt assembly with a removable cover member extruded in-line.

FIG. 6 illustrates the single co-extruded outer belt as it leaves the extrusion.

FIG. 7 is a view similar to FIG. 6 where the core and elastomer body material have been removed from the outer surface of the bright strip.

FIG. 8 shows a step of removing additional portions from the weatherstrip.

FIG. 9 shows further removal of elastomer, particularly from a rear surface of the bright strip.

FIG. 10 is a view of the bright strip before being formed into an integrated end.

FIG. 11 is an enlarged view of one end form.

FIG. 12 is a cross sectional view through a co-extruded section with integrated roll formed ends for an upper reveal portion of a glass run.

### DETAILED DESCRIPTION OF THE PREFERRED EMBODIMENTS

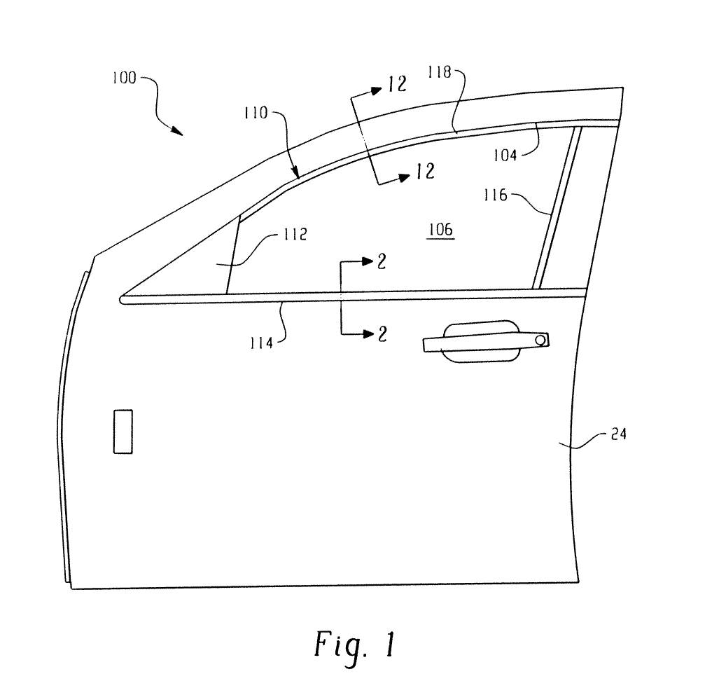

FIG. 1 shows a portion of an automotive vehicle 100 having a body that includes a front door 102. The door has a window opening 104 that is selectively closed by a movable window 106. The window is selectively raised and lowered relative to the door opening by a regulator (not shown) in a manner well known in the art.

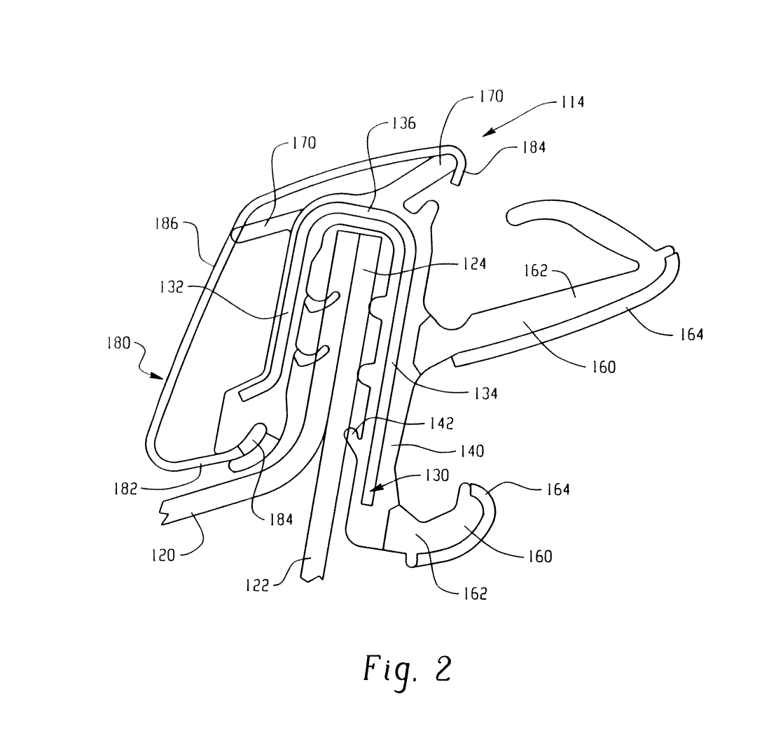

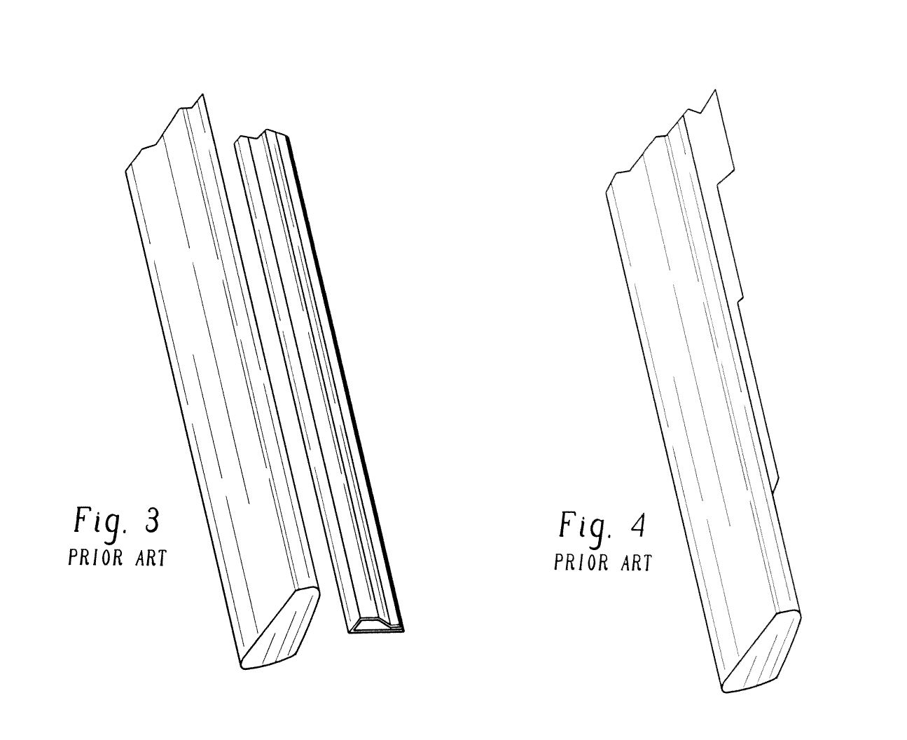

One or more weatherstrips or weatherseals 110 are provided on the body, door, and about the periphery of the door opening to seal the edge of the window and seal an interior compartment of the vehicle from the external elements. For example, the sealing system may include a mirror sail or other weatherstrip component 112 that seals along a front or A-pillar portion, a belt line seal 114, a B-pillar portion 116, and a header portion 118. It is oftentimes desired that one or more of these weatherstrips include a bright strip having a show surface (i.e., that portion that is visible externally of the vehicle) along selected regions of the vehicle. Because of the long length associated with these weatherstrips, it is common to manufacture these components via an extrusion process. Thus, with continued reference to FIG. 1, and additional reference to FIGS. 2-3, a conventional weatherstrip such as an outer belt 114 extends along a lower portion of the vehicle window opening from the A-pillar to the B-pillar. Inner and outer door panels 120, 122 are joined together adjacent the window opening and form a flange 124. The weatherstrip is secured over this flange 124. Particularly, the outer belt weatherstrip 114 includes a rigid core 130, shown here as an inverted, generally U-shaped member in cross-section, having first and second legs 132, 134 joined together adjacent one end by an interconnecting leg 136. The core may be formed of a wide variety of materials, but is oftentimes a rigid metal, and preferably aluminum because of its strength and light weight. Extruded about the core is a body, such as a rubber, plastic, or EPDM body (sometimes referred to as an elastomer or elastomeric body) 140. Oftentimes, the core is completely or substantially encapsulated by the body and includes one or more projecting retention fingers 142 that extend inwardly from the U-shaped body for gripping engagement with the door flange 124 so that when the U-shaped body is received over the flange, the outer belt is retained in place.

One or more seal members or seal lips 160 may be integrally formed in the extrusion or co-extrusion process. As shown in FIG. 2, seal lips 160 extend from the body and particularly extend inwardly toward the interior of the vehicle where the lips are disposed for sealing engagement with the door window (not shown). The seal lips could be formed of the same material as the remainder of the elastomeric body or, as shown here, are co-extruded with the body but formed of a different material. For example, the seal lip may be formed of a softer, more flexible material 162 that is co-extruded with the remainder of body that surrounds the core and the co-extruded materials form an integral, one-piece structure. Those portions of the seal lip that are disposed for engagement with the window may include a hard, low friction surface such as a flock or low-friction coating 164. In addition, one or more retention fingers 170 are co-extruded as a portion of the elastomeric body and facilitate in retention of the bright strip 180, shown here as a mechanically engaged, generally C-shaped cap that extends over the externally facing portion of the outer belt weatherstrip. Thus, one leg 182 of the generally C-shaped bright strip is mechanically received in a recess 184 in the body while an opposite hooked end 184 is snap-fit over one of the retention fingers 170 extending outwardly from the elastomeric body. In this manner, a show region 186 faces outwardly from the vehicle door and provides a bright strip or desired cosmetic show surface facing outwardly from the vehicle.

The core is preferably roll-formed prior to introduction into an extruding die and as the core proceeds through a die cavity, the elastomeric body, seal lips, gripping fingers, and retention fingers are co-extruded around the core. The various portions of this body may be formed of different materials due to the intended function or aesthetic purpose that is desired of this particular portion of the body. The particular types of materials, whether it be a rubber, plastic, EDPM, etc., or the particular hardness or still other properties of the materials should not be construed as limiting the present disclosure.

With continued reference to FIG. 2, and more particular reference to FIGS. 3 and 4, the extrusion is shown in the right-hand portion of FIG. 3 and the cap 180 is shown as a separate roll-formed component that has an integral end form. That is, the end may be cut and/or combined with a series of mechanical deforming steps that are undertaken to achieve the desired end configuration of the bright strip, and particularly one with roll-formed ends to provide a closed, seamless end received over the end of the extruded component. Thus, once mechanically engaged to the extruded component, the finished weatherstrip is shown in FIG. 4.

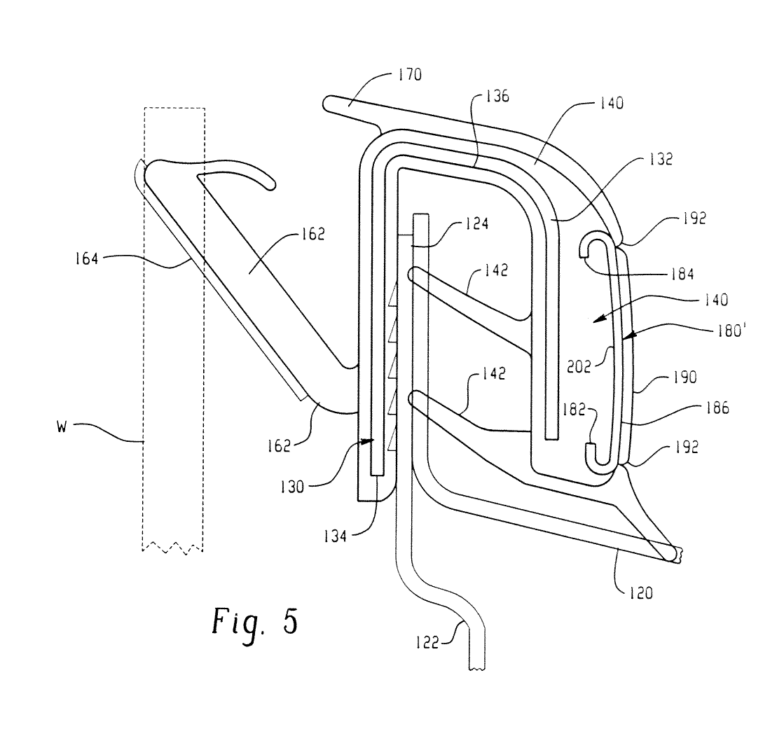

FIG. 5 is a cross-sectional view of the present disclosure and shows an outer belt generally similar to FIG. 2, but in which the bright strip 180′ is integrally formed to be part of the one-piece structure by co-extruding it with the core and elastomeric body as shown and described in commonly owned International Application WO 2008/157332. Again, for purposes of consistency and brevity, like reference numerals refer to like components. As described in the co-pending application the bright strip is covered with a removable cover member 190 with regions 192 of reduced thickness that aid in removing the cover member and exposing the bright strip.

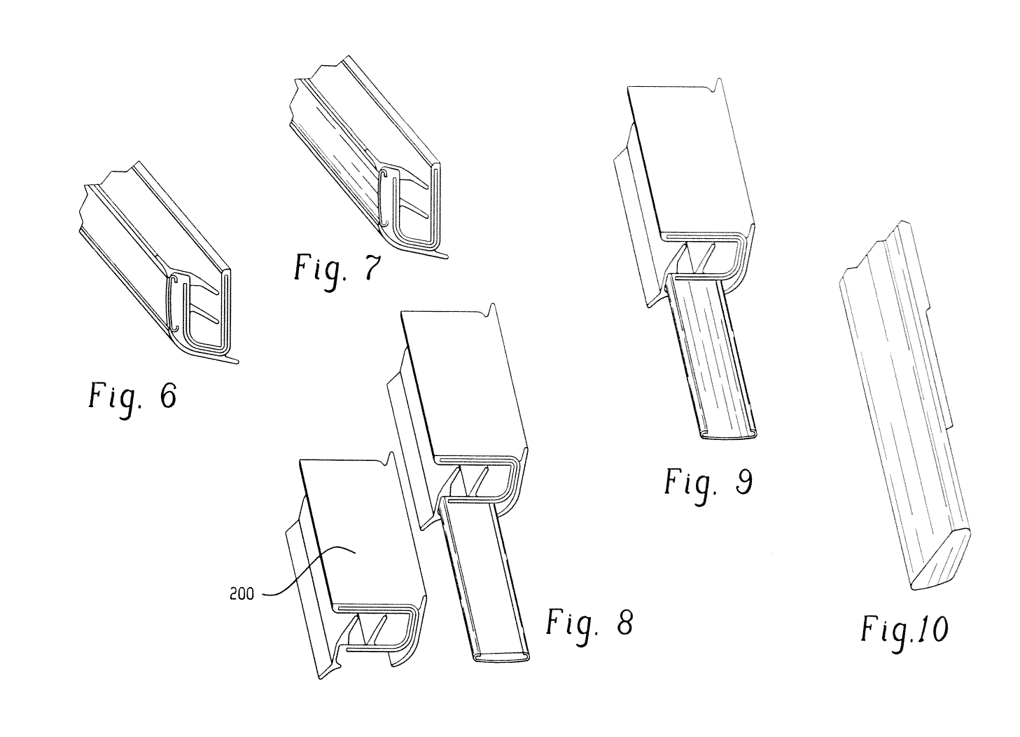

With continued reference to FIG. 5, and additional reference to FIGS. 6-10, the steps of forming a single co-extruded weatherstrip such as an outer belt with integrated end forms will be described in greater detail. For example, FIG. 6 illustrates the weatherstrip as the weatherstrip exits the extrusion line. Next, and as shown in FIG. 7, the cover 190 is removed from the bright strip. Again, thinned regions 192 may be provided to facilitate removal of the cover from the remainder of the co-extruded material.

Conventional tooling, and preferably a water jet, is used to remove an end segment of the body core in that region where an end form of the bright strip is to be created. Thus, segment 200 of the body core is physically removed from the remainder of the weatherstrip as represented in FIG. 8.

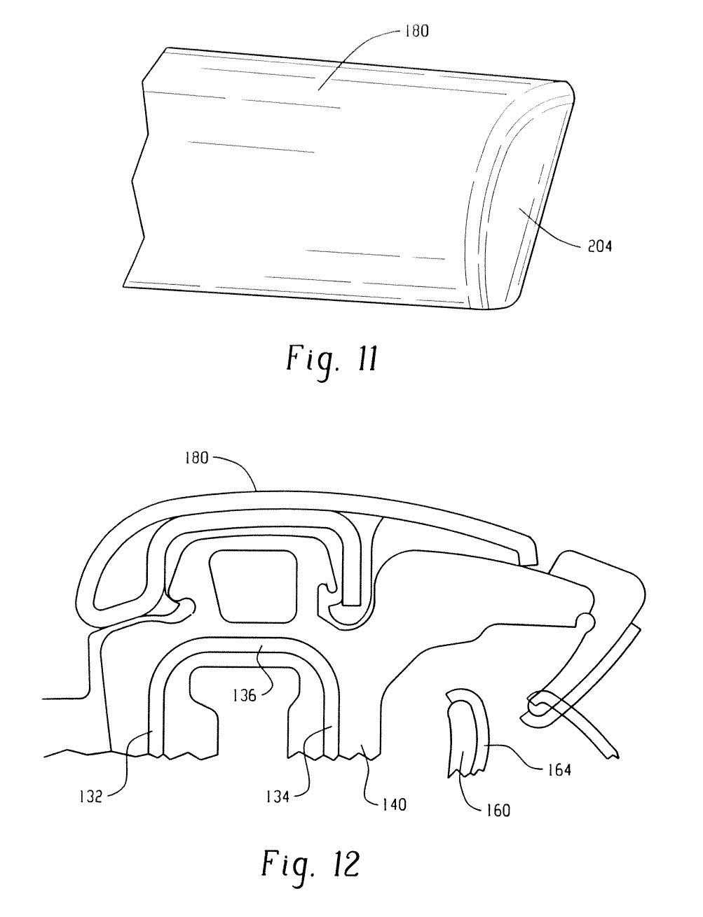

In FIG. 9, the extruded material is next removed from an internal or back surface 202 of the bright strip (compare FIGS. 8 and 9) in the region where the body core was removed. Again, preferably a water jet or other conventional tooling can be used to complete this removal of the elastomer body from the rear surface of the bright strip. Next, the extending portion of the bright strip from which the extrudate material has been removed, as well as the core in this region, undergoes a series of deforming steps to create an integral end form that is closed at end 204 and is seamless relative to the remainder of the length of the bright strip. The extended length as shown here, for example, extends rearwardly from the mirror sail portion of the outer belt. It will be understood, however, by one skilled in the art that the length of the exposed bright strip shown in FIGS. 9 and 10 may vary depending on the configuration and location of the end form as provided on the vehicle. In any event, the final structure is a one-piece, integrated weatherstrip that is modified at one or both ends after exiting the extrusion die and that provides a bright strip with an integrated, one-piece end form. No separate visible end caps are required. In some instances, separate inserts may be required at one or both ends of the extrusion that have retention features for installation onto the door. These retention inserts would not be visible once installed onto the door. Thus, it will be understood that a roll-formed component can be a one piece design (or could also be a two piece or three piece design if the door retention inserts are required and which are not visible once the weatherstrip is installed), and the bright strip is fed through the extrusion die and not separately joined or mechanically gripped to a separately formed extrusion component. FIG. 11 shows an enlarged portion of the end form 204 of the bright strip to demonstrate the seamless conformation of the bright strip along the end.

In FIG. 12, the extruded profile of the weatherstrip along the header portion or upper reveal portion of the glass run is shown. Although the conformation of the weatherstrip, including the bright strip portion, is different, the same principles as described above are used. That is, an outer bright strip, for example formed of a bright metal such as aluminum or stainless steel, is integrated into the extruded weatherstrip and need not be separately mechanically formed and subsequently assembled to an extruded component and thereby present as a bright strip/show surface for the weatherstrip on the vehicle.

In summary, a conventional two-piece design using a rolled end form or a cap that is mechanically joined to a separate extrusion is replaced with a co-extruded weatherstrip having an integrated, formed bright strip with integral end forms. The integrated end forms replace a separate end cap or molded end, and closes an opened end of the weatherstrip.

The disclosure has been described with reference to the preferred embodiments. Modifications and alterations will occur to others upon reading and understanding this specification.

We claim:

1. A weatherstrip comprising:
a body having a core formed of a first material and at least partially encapsulated in an elastomer;
a bright strip having a metal show surface that is integrated with the body;
an end region of the bright strip being configured from the bright strip material into an integral, one-piece closed end of the weatherstrip.

2. The weatherstrip of claim 1 wherein the integrated bright strip is at least partially encapsulated in the elastomer.

3. The weatherstrip of claim 2 wherein the elastomer is an extrudable material.

4. The weatherstrip of claim 1 wherein a cross-section through the body, elastomer, and bright strip has an extrudable profile.

5. The weatherstrip of claim 1 wherein the elastomer is removed in the end region of the bright strip.

6. The weatherstrip of claim 1 wherein the bright strip is formed of a first metal.

7. The weatherstrip of claim 6 wherein the first metal is stainless steel.

8. The weatherstrip of claim 7 wherein the core is made from a different, second metal.

9. The weatherstrip of claim 8 wherein the second metal is aluminum.

10. The weatherstrip of claim 6 wherein the core is made from a different, second metal.

11. The weatherstrip of claim 1 wherein the closed end is substantially perpendicular to the metal show surface.

12. The weatherstrip of claim 1 wherein the closed end is a continuous uninterrupted surface that extends from the metal show surface.

13. The weatherstrip of claim 1 wherein a rear surface opposite of the show surface of the bright strip is devoid of elastomer in the end region.

14. The weatherstrip of claim 1 wherein the rear surface is devoid of elastomer along an inner face of the closed end.

15. A method of forming a weatherstrip having a bright strip show surface comprising
providing a core;
providing a separate metal bright strip;
introducing the core and bright strip into an extrusion die;
extruding an elastomer body over the core and over at least a portion of the bright strip to secure the bright strip to the body;
removing select portions of the extruded elastomer body; and
mechanically forming at least one end region of the metal bright strip to create an integral closed end.

16. The method of claim 15 removing extruded material from a rear surface of the bright strip to allow the metal bright strip to be formed into an end.

17. The method of claim 15 wherein the removing step includes using a fluid jet.

18. The method of claim 15 wherein the mechanically forming step includes trimming bright strip material from the extruded weatherstrip.

19. The method of claim 18 wherein the trimming step includes using a fluid jet.

20. The method of claim 15 wherein the mechanically forming step includes roll forming the end region to create a seamless closed end.
